(19) United States
(12) Patent Application Publication
(10) Pub. No.: US 2022/0273044 A1
(43) Pub. Date: Sep. 1, 2022

(54) AEROSOL GENERATING SYSTEM

(71) Applicant: KT&G CORPORATION, Daejeon (KR)

(72) Inventors: Seung Won LEE, Gyeonggi-do (KR); Sung Wook YOON, Gyeonggi-do (KR); Dae Nam HAN, Seoul (KR)

(73) Assignee: KT&G CORPORATION, Daejeon (KR)

(21) Appl. No.: 17/058,186

(22) PCT Filed: Sep. 23, 2020
(86) PCT No.: PCT/KR2020/012839

§ 371 Date: Nov. 24, 2020

(30) Foreign Application Priority Data
Nov. 1, 2019 (KR) 10-2019-0138772

(51) Int. Cl. A24F 40/53; A24F 40/465; A24F 40/57; A24F 40/60

(52) U.S. Cl. CPC A24F 40/53; A24F 40/465; A24F 40/57; A24F 40/60

(57) ABSTRACT

An aerosol generating device includes: a susceptor heating an aerosol generating article; a coil surrounding the susceptor and heating the susceptor by generating a magnetic field when an alternating current voltage is applied; and a controller which applies a test voltage to the coil in response to a user input, measures an output current of the coil while changing a frequency of the test voltage, determines a frequency at which the output current becomes maximum, and applies an operating voltage having the determined frequency to the coil.

### TECHNICAL FIELD

One or more embodiments relate to an aerosol generating system.

### BACKGROUND ART

Recently, the demand for alternative methods of overcoming the shortcomings of general cigarettes has increased. For example, there is growing demand for a method of generating aerosol by heating an aerosol generating material in cigarettes, rather than by burning cigarettes.

In addition to an internal heating method and an external heating method, an induction heating method using a coil and a susceptor is used to heat an aerosol generating material. In the case of the induction heating method, when an alternating current voltage is applied to a coil, a magnetic field is generated, and a temperature of a heater (or a susceptor) is increased by the magnetic field. As an aerosol generating material is heated by the heater, an aerosol is generated.

### DISCLOSURE

### Technical Solution

A memory of an aerosol generating device stores a resonance frequency corresponding to a design standard of a coil. However, although a coil is made of the same standard and material, resistance deviation may occur in a production and assembly process, and thus, a resonance frequency may vary. Therefore, an actual heating temperature of a susceptor in the aerosol generating device may become different from a target temperature profile. One or more embodiments include an aerosol generating system capable of heating a susceptor according to a target temperature profile even when resistance deviation of a coil occurs. The technical problems to be achieved by one or more embodiments are not limited to the technical problems as described above, and other technical problems may be inferred from the following embodiments.

According to one or more embodiments, an aerosol generating device includes: a susceptor heating an aerosol generating article; a coil surrounding the susceptor and heating the susceptor by generating a magnetic field when an alternating current voltage is applied; and a controller electrically connected to the coil, wherein the controller applies a test voltage to the coil in response to a user input, measures an output current of the coil while changing a frequency of the test voltage, determines a frequency at which the output current becomes maximum, and applies an operating voltage having the determined frequency to the coil.

### Advantageous Effects

In one or more embodiments, a susceptor may be heated according to a target temperature profile by determining a resonance frequency for a coil and applying an operating voltage having the determined resonance frequency to the coil. Accordingly, even if a resonance frequency of a coil is different from the design standard due to resistance deviation occurring in a production and assembly process, an optimal smoking experience may be provided to a user in the same way as when a coil according to the design standard is used.

### DESCRIPTION OF THE DRAWINGS

FIG. 1 is a diagram illustrating an example in which an aerosol generating article is inserted into an internal heating-type aerosol generating device.

FIG. 2 is a diagram illustrating an example in which an aerosol generating article is inserted into an external heating-type aerosol generating device.

FIG. 3 is a diagram illustrating another example in which an aerosol generating article is inserted into an external heating-type aerosol generating device.

FIG. 4 is an RLC circuit diagram for explaining an induction heating method and a graph illustrating power transmitted to a load according to a frequency.

FIG. 5 is a diagram illustrating an example of an aerosol generating device using an induction heating method.

FIG. 6 is a block diagram illustrating a hardware configuration of an aerosol generating device.

FIG. 7 is a view illustrating an example of a cigarette.

FIG. 8 is a view illustrating an example of an aerosol generating system in which a cigarette is accommodated.

FIG. 9 is an example of a graph showing a change in a resonance frequency according to resistance deviation of a coil.

FIG. 10 is a graph showing an example in which a frequency of a PWM signal is changed.

FIG. 11 is a flowchart illustrating an example of a method of controlling an aerosol generating device.

FIG. 12 is a flowchart illustrating the method of FIG. 11 of controlling an aerosol generating device, in more detail.

### BEST MODE

According to one or more embodiments, an aerosol generating device includes: a susceptor heating an aerosol generating article; a coil surrounding the susceptor and heating the susceptor by generating a magnetic field when an alternating current voltage is applied; and a controller electrically connected to the coil, wherein the controller applies a test voltage to the coil in response to a user input, measures an output current of the coil while changing a frequency of the test voltage, determines a frequency at which the output current becomes maximum, and applies an operating voltage having the determined frequency to the coil.

The controller may determine the frequency at which the output current becomes maximum within a preset range by changing the frequency of the test voltage within the preset range.

The controller may receive a direct current (DC) voltage from a battery and thus generate a pulse width modulation (PWM) signal of the DC voltage, convert the PWM signal into the test voltage that is an alternating current (AC) voltage, and apply the test voltage to the coil.

The aerosol generating device may further include a feedback circuit, wherein the controller receives, through the feedback circuit, an output current of the coil which changes as a frequency of the test voltage changes and determines a frequency at which the output current becomes maximum by measuring the received output current.

The controller may, in a test mode, determine a frequency at which the output current becomes maximum by changing a frequency of a test voltage applied to the coil; enter a heating mode from the test mode after the frequency at which the output current becomes maximum is determined; and in the heating mode, apply the operating voltage having the determined frequency to the coil such that the susceptor is heated according to a target temperature profile.

The controller may, when a maximum value of the output current measured within the preset range is less than a preset reference value, determine that the coil is abnormal and may not supply power to the coil.

According to one or more embodiments, an aerosol generating system includes: a memory; a cavity accommodating at least a portion of a cigarette; a coil located around the cavity; a susceptor heated by the coil; and a controller electrically connected to the coil, wherein the controller measures an output current of the coil while changing a frequency of a test voltage applied to the coil; stores, in the memory, a frequency at which the output current of the coil becomes maximum; and starts heating of the susceptor by applying an operating voltage having the stored frequency to the coil.

The aerosol generating system may further include a cigarette, wherein the cigarette includes: a nicotine transfer unit heated by the susceptor; a nicotine generator connected to a downstream end of the nicotine transfer unit and heated by the susceptor; and a filter unit connected to a downstream end of the nicotine generator.

The controller may determine the frequency at which the output current becomes maximum by changing the frequency of the test voltage within a preset range, and store the determined frequency in the memory.

The controller may, after the frequency at which the output current of the coil becomes maximum is stored in the memory, in response to a user input for heating the susceptor, apply the operating voltage to the coil without applying the test voltage to the coil.

The controller may, when a maximum value of the output current measured within the preset range is less than a preset reference value, determine that the coil is abnormal and does not supply power to the coil.

### MODE FOR INVENTION

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used may be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “connected to” or “coupled to” another element or layer, it can be directly over, above, on, connected or coupled to the other element or layer or intervening elements or layers may be present. In contrast, when an element is referred to as being “directly over,” “directly above,” “directly on,” “directly connected to” or “directly coupled to” another element or layer, there are no intervening elements or layers present. Like numerals refer to like elements throughout.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, one or more embodiments will be described in detail with reference to the accompanying drawings.

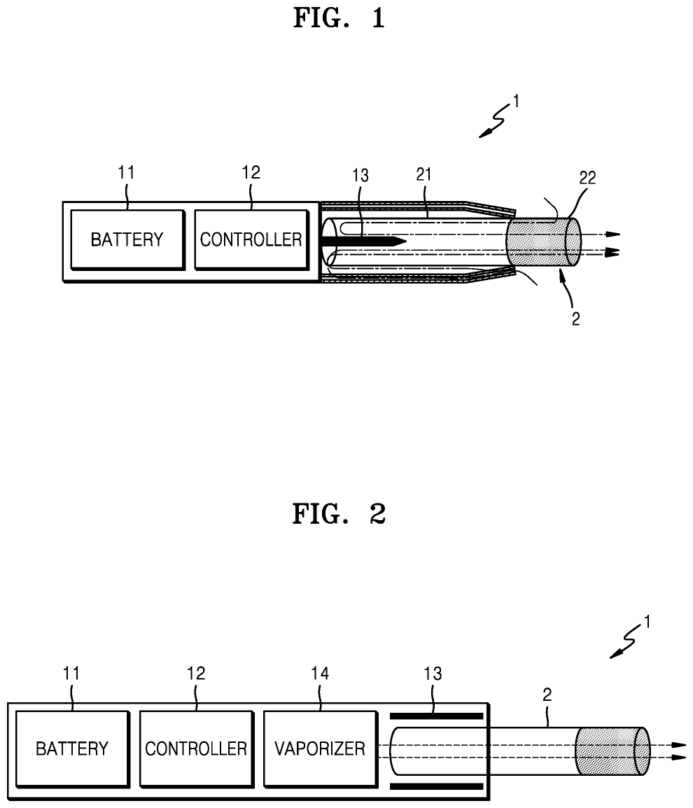

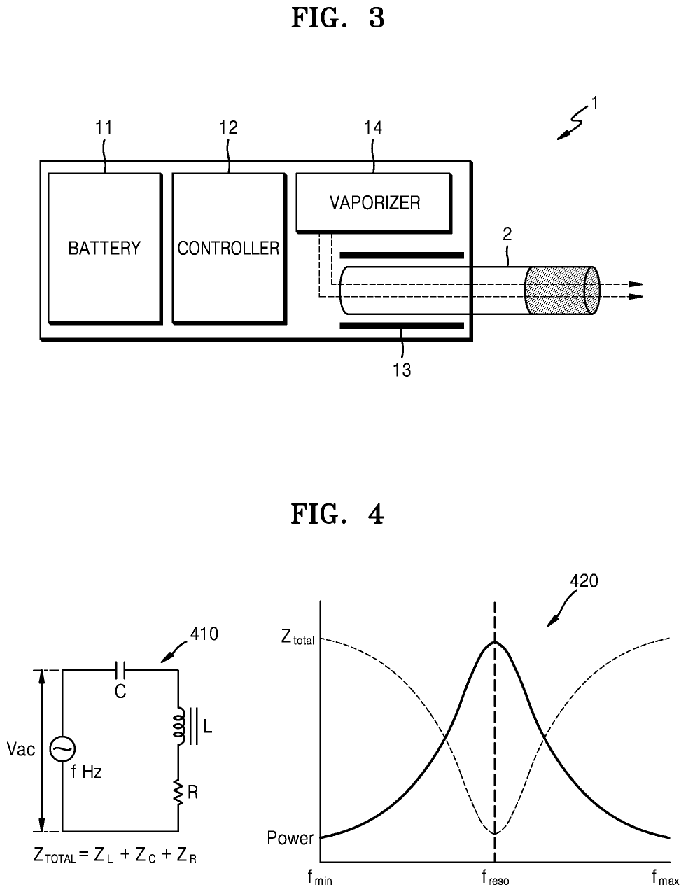

FIG. 1 is a diagram showing an example in which an aerosol generating article is inserted into an inside-heating aerosol generating device. FIG. 2 is a diagram showing an example in which an aerosol generating article is inserted into an outside-heating aerosol generating device. FIG. 3 is a diagram showing another example in which an aerosol generating article is inserted into an outside-heating aerosol generating device. Hereinafter, one or more embodiments will be described in detail with reference to FIGS. 1 through 3.

Referring to FIG. 1, the aerosol generating device 1 may include a battery 11, a controller 12, and a heater 13. Referring to FIGS. 2 and 3, the aerosol generating device 1 may further include a vaporizer 14. Also, the aerosol generating article 2 (e.g., a cigarette) may be inserted into an inner space of the aerosol generating device 1.

FIGS. 1 through 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 through 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 130 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 through 3. In other words, according to the design of the aerosol generating device 1, the battery 11, the controller 12, the heater 13, and the vaporizer 14 may be differently arranged.

When the cigarette 2 is inserted into the aerosol generating device 1, the aerosol generating device 1 may operate the heater 13 and/or the vaporizer 14 to generate an aerosol. The aerosol generated by the heater 13 and/or the vaporizer 14 is delivered to a user by passing through the cigarette 2.

As necessary, even when the cigarette 2 is not inserted into the aerosol generating device 1, the aerosol generating device 1 may heat the heater 13.

The battery 11 may supply power to be used for the aerosol generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the cigarette 2 is inserted into the aerosol generating device 1, the heater 13 may be located outside the cigarette 2. Thus, the heated heater 13 may increase a temperature of an aerosol generating material in the cigarette 2.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set as a temperature desired by a user.

As another example, the heater 13 may include an induction heater. In detail, the heater 13 may include a coil for heating a cigarette in an induction heating method, and the cigarette may include a susceptor which may be heated by the induction heater.

For example, the heater 13 may include a tube-type heating element, a plate-type heating element, a needle-type heating element, or a rod-type heating element, and may heat the inside or the outside of the cigarette 2, according to the shape of the heating element.

Also, the aerosol generating device 1 may include a plurality of heaters 13. Here, the plurality of heaters 13 may be inserted into the cigarette 2 or may be arranged outside the cigarette 2. Also, some of the plurality of heaters 13 may be inserted into the cigarette 2 and the others may be arranged outside the cigarette 2. In addition, the shape of the heater 13 is not limited to the shapes illustrated in FIGS. 1 through 3 and may include various shapes.

The vaporizer 14 may generate an aerosol by heating a liquid composition and the generated aerosol may pass through the cigarette 2 to be delivered to a user. In other words, the aerosol generated via the vaporizer 14 may move along an air flow passage of the aerosol generating device 1 and the air flow passage may be configured such that the aerosol generated via the vaporizer 14 passes through the cigarette 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting haptic information. Also, the aerosol generating device 1 may include at least one sensor (e.g., a puff detecting sensor, a temperature detecting sensor, a cigarette insertion detecting sensor, etc.). Also, the aerosol generating device 1 may be formed as a structure where, even when the cigarette 2 is inserted into the aerosol generating device 1, external air may be introduced or internal air may be discharged.

Although not illustrated in FIGS. 1 through 3, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The cigarette 2 may be similar as a general combustive cigarette. For example, the cigarette 2 may be divided into a first portion 21 including an aerosol generating material and a second portion 22 including a filter, etc. Alternatively, the second portion 22 of the cigarette 2 may also include an aerosol generating material. For example, an aerosol generating material made in the form of granules or capsules may be inserted into the second portion 22.

The entire first portion 21 may be inserted into the aerosol generating device 1, and the second portion 22 may be exposed to the outside. Alternatively, only a portion of the first portion 21 may be inserted into the aerosol generating device 1. In an embodiment, the entire first portion 21 and a portion of the second portion 22 may be inserted into the aerosol generating device 1. The user may puff aerosol while holding the second portion by the mouth of the user. In this case, the aerosol is generated by the external air passing through the first portion 21, and the generated aerosol passes through the second portion 22 and is delivered to the user's mouth.

For example, the external air may flow into at least one air passage formed in the aerosol generating device 1. For example, the opening and closing and/or a size of the air passage formed in the aerosol generating device 1 may be adjusted by the user. Accordingly, the amount and quality of the aerosol may be adjusted by the user. As another example, the external air may flow into the cigarette 2 through at least one hole formed in a surface of the cigarette 2.

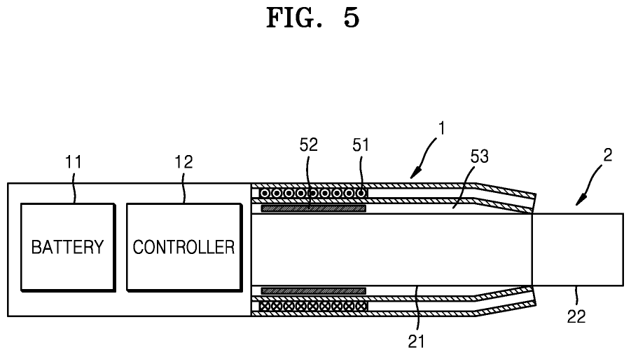

FIG. 4 is an RLC circuit diagram and a graph showing power transmitted to a load according to the frequency of a current flowing through the circuit.

A coil may be supplied with an alternating current from a battery. A magnetic field is generated by the coil that is supplied with the alternating current from the battery. As the magnetic field generated by the coil passes through a load (e.g., a susceptor), the load may be heated.

Referring to FIG. 4, the coil may be represented by an RLC circuit 410. The RLC circuit 410 includes inductance L, resistance R, and capacitance C. Total impedance Z_{TOTAL} of the

RLC circuit 410 is calculated as a sum of impedance Z_{L} of the inductance L, impedance Z_{R} of the resistance R, and impedance Z_{c} of the capacitance C.

The impedance Z_{L} of the inductance L, the impedance ZR of the resistance R, and the impedance Z_{C} of the capacitance C may be respectively expressed as in Equation 1 below.

$${Z}_{L} = ω L = 2 π \times f \times L \\ {Z}_{C} = - \frac{1}{ω C} = - \frac{1}{2 π \times f \times C} \\ {Z}_{R} = R \qquad [ Equation 1 ]$$

Resonance refers to a phenomenon in which as a vibration system periodically receives an external force having the same frequency as a natural frequency thereof, the amplitude increases significantly. The resonance is a phenomenon that occurs in all vibrations, such as mechanical and electrical vibrations. In general, when a force for vibrating the vibration system is applied to the vibration system from the outside, and the natural frequency of the vibration system is the same as a frequency of the force applied from the outside, the vibration becomes severe, and the amplitude increases.

Similarly, when a plurality of vibrating bodies which are separated within a preset distance vibrate at the same frequency, the plurality of vibrating bodies resonate with each other. In this case, resistance is reduced between the plurality of vibrating bodies.

A resonant frequency fᵣₑₛₒ of the RLC circuit 410 may be determined by, for example, Equation 2 below.

$$\begin{matrix}( 2 ) & \\ {f}_{reso} = 2 π \sqrt{\frac{1}{LC}} & [ Equation 2 ]\end{matrix}$$

Referring to a graph 420 of FIG. 4, when an alternating current having the resonant frequency fᵣₑₛₒis applied to the RLC circuit 410, maximum power may be transmitted to a load (e.g., a susceptor). As a frequency of an alternating current applied to the RLC circuit 410 is different from the resonant frequency fᵣₑₛₒ, a power value transmitted to the load decreases.

Referring to Equation 2 above, the resonant frequency fᵣₑₛₒ of the RLC circuit 410 is determined by the inductance L and the capacitance C of the coil. In a circuit forming a magnetic field by using a coil, inductance L may be determined by the number of windings of the coil and the like, and capacitance C may be determined by a distance, an area, and the like between the windings of the coil.

FIG. 5 is an example of an aerosol generating system using an induction heating method.

Referring to FIG. 5, an aerosol generating device 1 includes a battery 11, a controller 12, a coil 51, and a susceptor 52. A cavity 53 of the aerosol generating device 1 may accommodate at least a portion of a cigarette 2.

The aerosol generating device 1 illustrated in FIG. 5 shows elements related to the present embodiment. Therefore, it will be understood by one of ordinary skill in the art related to the present embodiment that the aerosol generating device 1 may further include other general-purpose elements in addition to the elements illustrated in FIG. 5.

The coil 51 may be located around the cavity 53. FIG. 5 illustrates that the coil 51 is arranged to surround the cavity 53, but it is not limited thereto.

When the cigarette 2 is accommodated in the cavity 53 of the aerosol generating device 1, the aerosol generating device 1 may supply power to the coil 51 such that the coil 51 may generate a magnetic field. As the magnetic field generated by the coil 51 passes through the susceptor 52, the susceptor 52 may be heated.

This induction heating phenomenon is a known phenomenon that can be explained by Faraday's Law of induction. In detail, when magnetic induction in the susceptor 52 changes, an electric field is generated in the susceptor 52, and thus, an eddy current flows in the susceptor 52. The eddy current generates, in the susceptor 52, heat that is proportional to current density and conductor resistance.

As the susceptor 52 is heated by the eddy current and an aerosol generating material in the cigarette 2 is heated by the susceptor 52 that is heated, the aerosol may be generated. The aerosol generated from the aerosol generating material passes through the cigarette 2 and is delivered to a user.

The battery 11 supplies power to be used for the aerosol generating device 1 to operate. For example, the battery 11 may supply power such that the coil 51 may generate a magnetic field and may supply power needed for operating the controller 12. Also, the battery 11 may supply power needed for operating a display, a sensor, a motor, and the like installed in the aerosol generating device 1.

The controller 12 controls an overall operation of the aerosol generating device 1. The controller 12 may be electrically connected to the coil 51. In detail, the controller 12 controls operations of other elements included in the aerosol generating device 1, as well as operations of the battery 11 and the coil 51. Also, the controller 12 may determine whether or not the aerosol generating device 1 is in an operable state by checking states of respective elements of the aerosol generating device 1.

The coil 51 may be an electrically conductive coil that generates a magnetic field by power supplied from the battery 11. The coil 51 may be arranged to surround at least a portion of the cavity 53. The magnetic field generated by the coil 51 may be applied to the susceptor 52 arranged at an inner end of the cavity 53.

The susceptor 52 may be heated as the magnetic field generated from the coil 51 passes through the susceptor 52 and may include metal or carbon. For example, the susceptor 52 may include at least one of ferrite, a ferromagnetic alloy, stainless steel, and aluminum.

Also, the susceptor 52 may include at least one of graphite, molybdenum, silicon carbide, niobium, a nickel alloy, a metal film, ceramic such as zirconia, transition metal such as nickel (Ni) cobalt (Co), and metalloid such as boron (B) and phosphorus (P). However, the susceptor 52 is not limited to the example described above and may include all susceptors that may be heated to a wanted temperature as a magnetic field is applied thereto. Here, the wanted temperature may be preset in the aerosol generating device 1 or may be set to a temperature wanted by a user.

When the cigarette 2 is accommodated in the cavity 53 of the aerosol generating device 1, the susceptor 52 may be arranged to surround at least a portion of the cigarette 2. Therefore, the heated susceptor 52 may raise a temperature of the aerosol generating material in the cigarette 2.

FIG. 5 illustrates that the susceptor 52 is arranged to surround at least a portion of the cigarette 2, but the arrangement of the susceptor 52 is not limited thereto. For example, the susceptor 52 may include a tube-type heating element, a plate-type heating element, a needle-type heating element or a rod-type heating element and may heat an inside and/or an outside of the cigarette 2 according to a shape of a heating element.

Also, the aerosol generating device 1 may also include a plurality of susceptors 52 arranged therein. Here, the plurality of susceptors 52 may be arranged to be inserted into the cigarette 2 or may be arranged outside the cigarette 2. Also, some of the plurality of susceptors 52 may be arranged to be inserted into the cigarette 2, and the others may be arranged outside the cigarette 2. In addition, the shape of the susceptor 52 is not limited to the shape illustrated in FIG. 5 and may be formed in various shapes.

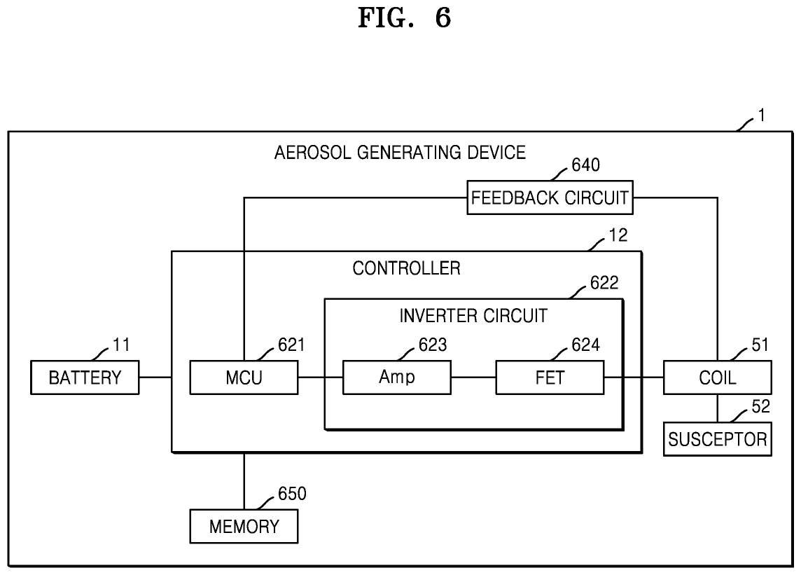

FIG. 6 is a block diagram illustrating a hardware configuration of an aerosol generating device according to an embodiment.

Referring to FIG. 6, an aerosol generating device 1 may include a battery 11, a controller 12, a coil 51, a susceptor 52, a feedback circuit 640, and a memory 650.

The battery 11 is a direct current power source and supplies a direct current (DC) voltage to the controller 12 for an operation of the aerosol generating device 1. In an embodiment, a regulator for keeping a voltage of the battery 11 constant may be included between the battery 11 and the controller 12.

The controller 12 may include a microcontroller unit (MCU) 621 and an inverter circuit 622. The inverter circuit 622 may include an amplifier (Amp) 623 and a field effect transistor (FET) 624. However, it will be understood by one of ordinary skill in the art related to the present embodiment that other components may be further included, in addition to the components illustrated in FIG. 6.

The controller 12 may receive a DC voltage from the battery 11, generate a control signal, and transmit the generated control signal to another component of the aerosol generating device 1. The controller 12 may collectively control the battery, the coil, the feedback circuit 640, and the memory 650 by using the control signal.

The MCU 621 is supplied with a DC voltage from the battery 11 to generate a pulse width modulation (PWM) signal. The MCU 621 changes a frequency of the PWM signal within a preset range and transmits the PWM signal to the inverter circuit 622. In detail, the MCU 621 includes two ports, and each of the two ports transmits a PWM signal of the same waveform to the inverter circuit 622. According to an embodiment, a PWM signal output from the MCU 621 may be a digital PWM signal.

The inverter circuit 622 may convert a PWM signal of a DC voltage received from the MCU 621 into an alternating current (AC) voltage. The inverter circuit 622 may receive two PW signals of the same waveform from the MCU 621 and perform logic operation and amplification for converting the two PWM signals into an AC voltage. The inverter circuit 622 may apply an AC voltage to the coil 51.

When the AC voltage is applied from the inverter circuit 622 to the coil 51, the coil 51 generates a magnetic field. The frequency of the AC voltage transmitted from the inverter 622 to the coil 51 may be determined according to a frequency of a PWM signal transmitted from the MCU 621 to the inverter circuit 622. In other words, as a frequency of a PWM signal generated from the MCU 621 is changed, a frequency of an AC voltage applied to the coil 51 is accordingly changed.

In detail, the inverter circuit 622 may include the Amp 623 and the FET 624. The Amp 623 may be implemented as an array of a plurality of logic gates. The Amp 623 may receive PWM signals generated from the two ports of the MCU 621 and perform logic operation by using the plurality of logic gates. Also, the Amp 623 may amplify the PWM signals received from the MCU 621 according to a preset amplification factor. The Amp 623 may perform logic operation and amplification on the PWM signals and transmit the PWM signals to the FET 624. The logic operation and amplification on the PWM signals may be performed by the Amp 623 so that the PWM signals are converted into an AC voltage in the FET 624.

The FET 624 may convert the PWM signals received from the Amp 623 into the AC voltage and transmit the AC voltage to the coil 51. The FET 624 may be opened and closed according to a PWM signal or a timer. According to one or more embodiments, the FET 624 may be replaced with a switch.

The coil 51 may receive the AC voltage from the controller 12. When the AC voltage is applied from the controller 12 to the coil 51, the coil 51 may generate a magnetic field. The strength of the magnetic field generated by the coil 51 may vary according to resistance or the like of the coil 51.

The susceptor 52 may be located inside the coil 51. The susceptor 52 may heat an aerosol generating article by generating heat within the magnetic field generated from the coil 51. The heat generated by the susceptor 52 may vary according to the strength of the magnetic field generated by the coil 51.

The feedback circuit 640 may transmit, to the MCU 621, an output current flowing through the coil 51. As a frequency of the AC voltage applied to the coil 51 is changed, the output current flowing through the coil 51 varies. In other words, the feedback circuit 640 may measure the output current of the coil 51 that continuously varies as the frequency of the AC voltage applied to the coil 51 changes, and transmit the measured output current to the MCU 621.

The MCU 621 may determine a frequency of the AC voltage applied to the coil 51 when the output current of the coil 51 received from the feedback circuit 640 becomes maximum. The MUC 621 may enable the susceptor 51 to be heated by generating a PWM signal having the determined frequency. The determined frequency may be a resonance frequency of the coil 51.

The memory 650 is hardware storing various types of data processed by the aerosol generating device 1. The memory 650 may store pieces of data processed by the controller 12 and pieces of data to be processed by the controller 12. The memory 650 may be implemented as various types such as random access memory (RAM) such as dynamic random access memory (DRAM) and static random access memory (SRAM), read-only memory (ROM), and electrically erasable programmable read-only memory.

The memory 650 may store data regarding an operation time of the aerosol generating device 1, at least one temperature profile, at least one power profile, a smoking pattern of a user, and the like. Also, the memory 650 may store information regarding a resonance frequency of the coil 51 determined by the controller 12. The information regarding the resonance frequency of the coil 51 stored in the memory 650 may be used to heat the susceptor 52.

In an embodiment, the aerosol generating device 1 may have a plurality of modes. For example, a mode of the aerosol generating device 1 may include a sleep mode, a test mode, and a heating mode. However, the mode of the aerosol generating device 1 is not limited thereto.

When the aerosol generating device 1 is not used, the aerosol generating device 1 may maintain the sleep mode. In the sleep mode, the controller 12 may control an output voltage of the battery 11 so that power is not supplied to the coil 51. For example, before or after the use of the aerosol generating device 1, the aerosol generating device 1 may enter the sleep mode.

In response to a user input to the aerosol generating device 1, the controller 12 may set the mode of the aerosol generating device 1 to the test mode (or may switch the mode from the sleep mode to the test mode). In the test mode, the controller 12 may determine a resonance frequency corresponding to the coil 51 by changing a frequency of a test voltage applied to the coil 51. The test voltage is an AC voltage applied to the coil 51 in the test mode. The test voltage is a voltage applied to the coil 51 to determine a resonance frequency and is different from an operating voltage used to heat the susceptor 52 in the heating mode.

Also, after the resonance frequency is determined, the controller 12 may switch the mode of the aerosol generating device 1 from the test mode to the heating mode. In the heating mode, the controller 12 starts heating of the susceptor 52 by applying an operating voltage having the resonance frequency determined in the test mode. The operating voltage is an AC voltage applied to the coil 51 that is used in the heating mode. As the operating voltage having the resonance frequency is applied to the coil 51, the susceptor 52 may be heated according to a target temperature profile in the heating mode.

A temperature profile indicates a change in temperature of the susceptor 52 over time and may provide an optimal smoking experience to a user when the susceptor 52 is heated according to the target temperature profile.

In another embodiment, the aerosol generating device 1 may determine whether or not the aerosol generating device 1 is to enter the test mode, according to an input of the user. When an input of the user for determining a resonance frequency of the coil 51 is received, the aerosol generating device 1 may determine the resonance frequency by entering the test mode from the sleep mode and start heating of the susceptor 52 by entering the heating mode from the test mode.

When an input of the user for heating the susceptor 52 is received after information regarding the resonance frequency is stored in the memory 650, the aerosol generating device 1 may omit to enter the test mode, enter the heating mode from the sleep mode, and apply, to the coil 51, an operating voltage having the resonance frequency stored in the memory 650, thereby starting heating of the susceptor 52.

In another embodiment, the test mode may be executed in an inspection process of inspecting an error in manufacturing of the coil 51 before the aerosol generating device 1 is distributed to the user. In the inspection process of the aerosol generating device 1, the aerosol generating device 1 may enter the test mode, and a resonance frequency determined in the inspection process may be stored in the memory 650.

After the aerosol generating device 1 is distributed to the user, the aerosol generating device 1 may be immediately switched from the sleep mode to the heating mode without undergoing the test mode. In the heating mode, as an operating voltage having the resonance frequency determined in the inspection process is applied to the coil 51, heating of the susceptor 52 may start.

However, descriptions of an input method and an input subject for execution of the test mode are not limited to the examples described above, and various modifications and equivalent other embodiments may be made therefrom.

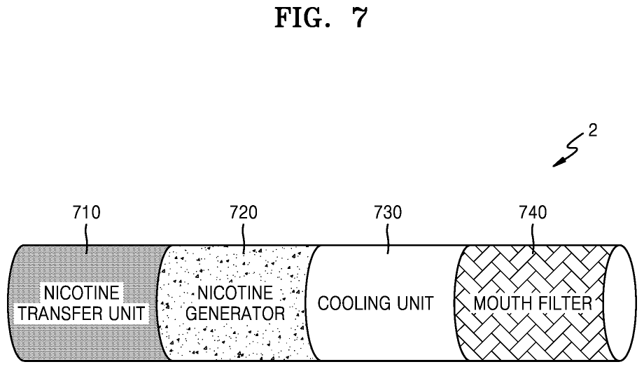

FIG. 7 is a view illustrating an example of a cigarette according to an embodiment.

Referring to FIG. 7, a cigarette 2 includes a nicotine transfer unit 710, a nicotine generator 720, and a filter unit. The filter unit includes a cooling unit 730 and a mouth filter 740. As needed, the filter unit may further include a segment performing another function.

The nicotine transfer unit 710 includes an aerosol generating material. The nicotine transfer unit 710 may include at least one of glycerin, propylene glycol, ethylene glycol, dipropylene glycol, diethylene glycol, triethylene glycol, tetraethylene glycol, and oleyl alcohol but is not limited thereto. The nicotine transfer unit e710 may be heated such that an aerosol may be generated.

The nicotine generator 720 includes a tobacco material including nicotine. The nicotine generator 720 may include a tobacco material such as tobacco leaves, a reconstituted tobacco, and tobacco granules. The nicotine generator 720 may be formed as a sheet, strands, or shredded tobacco which is formed of tiny bits cut from a tobacco sheet.

The cooling unit 730 cools an aerosol generated by heating at least one of the nicotine transfer unit 710 and the nicotine generator 720. Therefore, a user may puff the aerosol cooled at an appropriate temperature.

The mouth filter 740 may be a cellulose acetate filter.

The mouth filter 740 may be a cylindrical type or a tube type having a hollow inside. Also, the mouth filter 740 may be a recessed type.

The aerosol generated by the nicotine transfer unit 710 and the nicotine generator 720 is cooled by passing through the cooling unit 730, and the cooled aerosol is delivered to the user through the mouth filter 740. Therefore, when a flavoring element is added to the mouth filter 740, the persistence of flavors delivered to the user may be enhanced.

Although not illustrated in FIG. 7, the cigarette 2 may be packaged by at least one wrapper. The wrapper may have at least one hole through which external air may be introduced or internal air may be discharged. As an example, the cigarette 2 may be packaged by one wrapper. As another example, the cigarette 2 may be double-packaged by two or more wrappers.

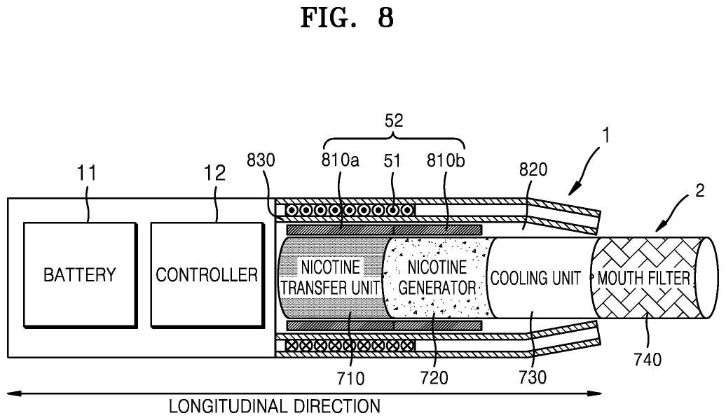

FIG. 8 is a view illustrating an example of an aerosol generating system in which a cigarette is inserted.

The aerosol generating system includes an aerosol generating device 1 and a cigarette 2.

The aerosol generating device 1 may include a battery 11, a controller 12, a coil 51, a susceptor, and a cavity 820. The cigarette 2 may include a nicotine transfer unit 710, a nicotine generator 720, a cooling unit 730, and a mouth filter 740. However, it will be understood by one of ordinary skill in the art related to the present embodiment that other elements may be further included in addition to the elements illustrated in FIG. 8.

The susceptor 52 may be part of the aerosol generating device 1. The susceptor 52 may extend in a longitudinal direction of the cavity 820 along an inner wall 830 forming the cavity 820.

The cigarette 2 may include the nicotine transfer unit 710 and the nicotine generator 720 connected to a downstream end of the nicotine transfer unit 710.

The nicotine transfer unit 710 includes a moisturizer (e.g., glycerin, propylene glycol, or the like), and an aerosol (atomization) is generated as the nicotine transfer unit 710 is heated. The nicotine generator 720 includes a tobacco material (e.g., tobacco leaves, a reconstituted tobacco, tobacco granules, or the like) including nicotine, and nicotine is generated as the nicotine generator 720 is heated.

When a cigarette 2 is accommodated in the cavity 820 of the aerosol generating device 1, the susceptor 52 may be located to surround an outside of the cigarette 2. Here, the susceptor 52 may be located at a position corresponding to a transfer unit 710 and a nicotine generator 720.

The susceptor 52 may be part of the cigarette 2. The susceptor 52 may be located on an outer surface of the cigarette 2 to extend along a longitudinal direction of the cigarette 2. Also, the susceptor 52 may be packaged by at least one wrapper.

When the cigarette 2 is accommodated in the cavity 820 of the aerosol generating device 1, the aerosol generating device 1 may supply power to the coil 51 such that the coil 51 may generate a magnetic field. As the magnetic field generated by the coil 51 and the coil 51 passes through the susceptor 52, the susceptor 52 may heat the nicotine transfer unit 710 and the nicotine generator 720.

In another embodiment, the susceptor 52 may include a first portion 810a of a susceptor and a second portion 810b of the susceptor. Here, a first portion 810a of the susceptor may be located at a position corresponding to a transfer unit 710, and a second portion 810b of the susceptor may be located at a position corresponding to a nicotine generator 720.

Since materials included in the nicotine transfer unit 710 and the nicotine generator 720 are different, heating temperatures of the nicotine transfer unit 710 and the nicotine generator 720 for proving a user with a best tobacco taste may be different.

To heat the nicotine transfer unit 710 and the nicotine generator 720 at different temperatures, heating temperatures of the first portion 810a of the susceptor and the second susceptor 810b of the susceptor may be different. In other words, since the first portion 810a of the susceptor heats the nicotine transfer unit 710, and the second portion 810b of the susceptor heats the nicotine generator 720, heating temperatures of the nicotine transfer unit 710 and the nicotine generator 720 become different.

When the first portion 810a of the susceptor and the second portion 810b of the susceptor are part of the cigarette 2, the first portion 810a of the susceptor and the second portion 810b of the susceptor may be connected to each other to form a single heating body or may be separated from each other to be respectively located at positions corresponding to the nicotine transfer unit 710 and the nicotine generator 720.

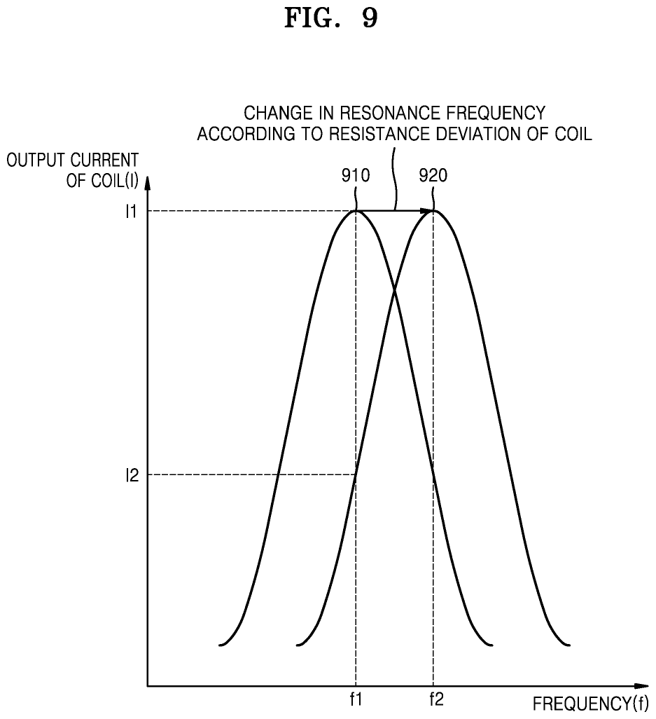

FIG. 9 is an example of a graph illustrating a change in a resonance frequency according to resistance deviation of a coil.

Referring to a graph 910 for a coil having resistance according to a design standard, the coil has a resonance frequency f1. Referring to a graph 920 for a coil in which resistance deviation has occurred in a production and assembly process, the coil has a resonance frequency f2.

When f1, which is a resonance frequency according to a design standard, is applied to the coil for the graph 910 and the coil for the graph 920, the coil for the graph 910 may resonate and a maximum output current I1 may flow through the coil for the graph 910. However, because f1 does not correspond to a resonance frequency of the coil for the graph 920, an output current I2 that is lower than the maximum output current I1 may flow through the coil for the graph 920. Accordingly, when an AC voltage having a preset frequency (e.g., f1) is applied to a coil with resistance deviation, a susceptor may not be controlled according to a target temperature profile unless the frequency is adjusted.

In other words, when the susceptor is heated by applying the AC voltage to the coil, a frequency of the AC voltage applied to the coil may be corrected from the resonance frequency f1 of the coil to the resonance frequency f2 of the coil to control the susceptor according to the target temperature profile.

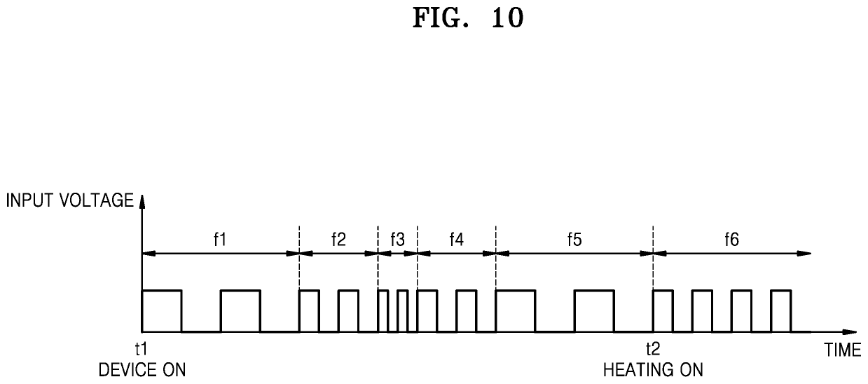

FIG. 10 is a graph illustrating an example in which a frequency of a PWM signal is changed.

As a user input is received for an aerosol generating device, a controller may start operation of the aerosol generating device. For example, the controller may start the operation of the aerosol generating device by receiving the user input through interfacing elements (e.g., a button or a touch screen).

FIG. 10 illustrates a waveform of a PWM signal of a DC voltage generated by a controller. A frequency of an AC voltage applied to a coil may be determined according to a frequency of the PWM signal. In other words, as the frequency of the PWM signal is changed from f1 through f6, the frequency of the AC voltage applied to the coil is also changed from f1 through f6.

The controller may start an operation for determining a resonance frequency by switching a mode of the aerosol generating device from a sleep mode to a test mode at t1.

At each of frequencies f1, f2, f3, f4, and f5, an input voltage may be the same, and each PWM duty ratio may also be the same. The frequencies f1 and f5 may be the same, and the frequencies f2 and f4 may also be the same. A frequency of a PWM signal generated by the controller may be changed by repeatedly increasing and decreasing within a preset range.

FIG. 10 illustrates merely one period from t1 to t2, but the controller may generate a PWM signal by repeating a period several times to determine a resonance frequency. In an embodiment of FIG. 10, there is only one frequency f2 between the frequency f1 and the frequency f3. However, in another embodiment, the steps of changing a frequency may be further divided. The method of changing a frequency is not limited to the example described above.

In an embodiment, when an output current of a coil measured by the controller appears maximum at the frequencies f2 and f4, the controller may determine, as a resonance frequency, the frequency f6 that is the same as the frequencies f2 and f4. After the resonance frequency is determined, the controller may switch the mode of the aerosol generating device from the test mode to a heating mode at t2. In the heating mode, the controller may generate a PWM signal having the frequency f6 and apply, to the coil, an AC voltage having the resonance frequency f6.

FIG. 10 illustrates an example in which, in the test mode, a frequency increases and then decreases within a preset range. However, the method of changing the frequency is not limited to the example described above, and may include a method of increasing or decreasing a frequency in one direction as well as a method of decreasing first and then increasing a frequency within a preset range.

The time period from t1 to t2 for the test mode may be a short time, which may not be recognized by a user. For example, the time period from t1 to t2 may be about 0.5 seconds to about 2 seconds. Alternatively, the time period may be 1 second.

In another embodiment, a frequency of a PWM signal generated by the controller may be fixed, and a duty ratio of the PWM signal may be generated by being changed within a preset range. That is, duty ratios at the frequencies f1, f2, f3, f4, and f5 may not be constant. For example, the duty ratios at the frequencies f1 and f5 may be the same, and the duty ratios at the frequencies f2 and f4 may also be the same. The duty ratio of the PWM signal generated by the controller may be changed by repeatedly increasing and decreasing within a preset range. As the duty ratio is changed, an amount of power supplied to the coil may be changed. As the duty ratio of the PWM signal increases, the amount of the power supplied to the coil may increase, and heating of a susceptor may be accelerated.

However, the method of changing the duty ratio is not limited to the examples described above, and may include a method of increasing or decreasing the duty ratio in one direction as well as a case of decreasing first and then increasing the duty ratio within a preset range.

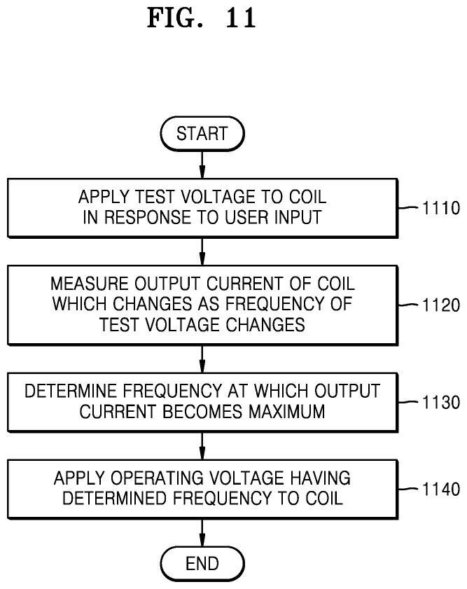

FIG. 11 is a flowchart illustrating a method of controlling an aerosol generating device, according to one embodiment.

Referring to FIG. 11, in operation 1110, an aerosol generating device may apply a test voltage to a coil in response to a user input.

In the aerosol generating device, a resonance frequency corresponding to a design standard of the coil is stored in a memory. However, even when the coil is made of the same standard and material, resistance deviation may occur in a production and assembly process, and thus, the resonance frequency may vary. The aerosol generating device may apply the test voltage to the coil in response to the user input to determine the resonance frequency, which might have been affected by such deviation, before a susceptor is heated.

In operation 1120, the aerosol generating device may measure an output current of the coil, which varies as a frequency of the test voltage is changed.

In operation 1130, the aerosol generating device may determine a frequency at which the output current becomes maximum.

The frequency at which the output current becomes maximum may be a resonance frequency of the coil. The aerosol generating device may measure the output current of the coil and thereby determine, as a resonance frequency, a frequency corresponding to a maximum output current. As such, the resonance frequency which is affected by resistance deviation may be corrected.

In operation 1140, the aerosol generating device may apply an operating voltage having the determined frequency to the coil.

The aerosol generating device may flow the maximum output current through the coil by applying the operating voltage having the determined frequency to the coil. Compared to when an AC voltage having a non-resonance frequency is applied to the coil, a larger output current may flow through the coil due to resonance when the aerosol generating device applies the operating voltage having the resonance frequency to the coil, even if the same power is supplied to the coil. Therefore, the strength of a magnetic field generated by the coil may increase, and thus, the susceptor may be heated according to a target temperature profile.

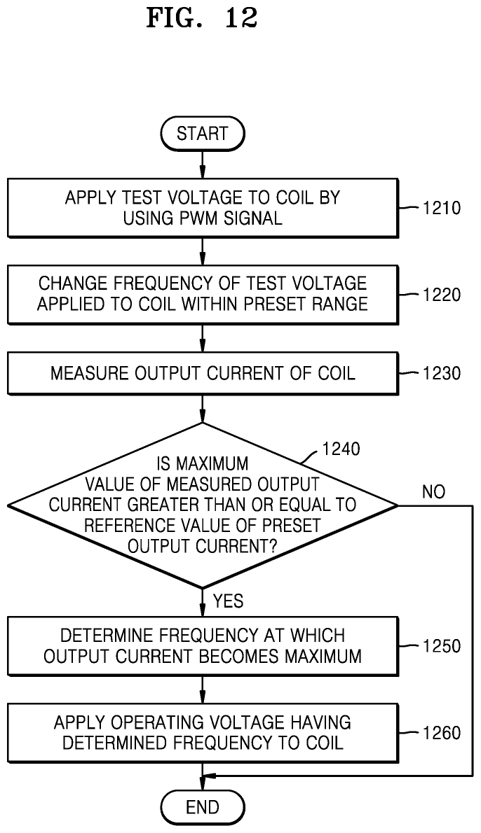

FIG. 12 is a flowchart illustrating in more detail the method of FIG. 11 of controlling an aerosol generating device, according to one embodiment.

Referring to FIG. 12, in operation 1210, an aerosol generating device may apply a test voltage to a coil by using a PWM signal.

In detail, the aerosol generating device may be supplied with a DC voltage from a battery and thus generate a PWM signal of a DC voltage. The aerosol generating device may convert the PWM signal into an AC voltage and apply the AC voltage to the coil.

In operation 1220, the aerosol generating device may change, within a preset range, a frequency of the test voltage applied to the coil.

The PWM signal generated by the aerosol generating device may be a fixed voltage and a frequency of the PWM signal may vary over time. A preset range in which a controller changes a frequency may differ according to a design standard of the coil. For example, when a resonance frequency according to the design standard of the coil is 300 kHz, the preset range in which the controller changes the frequency may be about 280 kHz to about 320 kHz. However, this is merely one embodiment, and the preset range in which the controller changes the frequency is not limited thereto.

In operation 1230, the aerosol generating device may measure an output current of the coil.

As a frequency of the AC voltage applied to the coil is changed, the output current flowing through the coil varies. The aerosol generating device may use a feedback circuit to transmit, to the controller, the output current of the coil, which continuously varies as a frequency of the AC voltage applied to the coil is changed.

In operation 1240, the aerosol generating device may determine whether or not a maximum value of the measured output current is greater than or equal to a reference value of a preset output current. On the basis of a result of operation 1240, the aerosol generating device may control power supplied to the coil.

The reference value of the preset output current may be a minimum value of the output current flowing through the coil which enables the aerosol generating device to operate normally. The reference value of the preset output current may be set on the basis of a design standard of the aerosol generating device. When the aerosol generating device determines that the maximum value of the measured output current is less than the reference value of the preset output current, the aerosol generating device may not enter the heating mode and may stop supplying power to the coil. Also, the aerosol generating device may output a notification that the aerosol generating device may not operate. The aerosol generating device may induce replacement of the aerosol generating device by notifying a user that the aerosol generating device may not operate due to the invalidity of the coil.

When the aerosol generating device determines that the maximum value of the measured output current is greater than or equal to the reference value of the preset output current, the method may proceed to operation 1250. In operation 1250, the aerosol generating device may determine a frequency at which the output current becomes maximum. The determine frequency may be a resonance frequency of the coil.

In operation 1260, the aerosol generating device may apply an operating voltage having the determined frequency to the coil. The aerosol generating device may start heating of a susceptor by switching the test mode to a heating mode.

At least one of the components, elements, modules or units (collectively “components” in this paragraph) represented by a block in the drawings, such as the controller 12, the vaporizer 14, or the MCU 621 may be embodied as various numbers of hardware, software and/or firmware structures that execute respective functions described above, according to an exemplary embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above exemplary embodiments may be implemented in algorithms that execute on one or more processors. Furthermore, the components represented by a block or processing steps may employ any number of related art techniques for electronics configuration, signal processing and/or control, data processing and the like.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

What is claimed is:

1. An aerosol generating device comprising:
a susceptor configured to heat an aerosol generating article;
a coil surrounding the susceptor and configured to heat the susceptor by generating a magnetic field when an alternating current voltage is applied; and
a controller electrically connected to the coil and configured to:
apply a test voltage to the coil in response to a user input,
measure an output current of the coil while changing a frequency of the test voltage,
determine a frequency at which the output current becomes maximum, and
apply an operating voltage having the determined frequency to the coil.

2. The aerosol generating device of claim 1, wherein the controller determines the frequency at which the output current becomes maximum within a preset range by changing the frequency of the test voltage within the preset range.

3. The aerosol generating device of claim 1, wherein the controller receives a direct current (DC) voltage from a battery, generates a pulse width modulation (PWM) signal of the DC voltage, converts the PWM signal into the test voltage that is an alternating current (AC) voltage, and applies the test voltage to the coil.

4. The aerosol generating device of claim 1, further comprising a feedback circuit, wherein the controller is further configured to:
receive, through the feedback circuit, the output current of the coil which changes as a frequency of the test voltage changes; and
determine the frequency at which the output current becomes maximum by measuring the received output current.

5. The aerosol generating device of claim 1, wherein the controller is further configured to:
in a test mode, determine the frequency at which the output current becomes maximum by changing the frequency of the test voltage applied to the coil;
enter a heating mode from the test mode after the frequency at which the output current becomes maximum is determined; and
in the heating mode, apply the operating voltage having the determined frequency to the coil such that the susceptor is heated according to a target temperature profile.

6. The aerosol generating device of claim 2, wherein the controller, based on a maximum value of the output current measured within the preset range being less than a preset reference value, determines that the coil is abnormal and does not supply power to the coil.

7. An aerosol generating system comprising:
a memory;
a cavity configured to accommodate at least a portion of a cigarette;
a coil located around the cavity;
a susceptor configured to be heated by the coil; and
a controller electrically connected to the coil and configured to:
measure an output current of the coil while changing a frequency of a test voltage applied to the coil;
store, in the memory, a frequency at which the output current of the coil becomes maximum; and
start heating of the susceptor by applying an operating voltage having the stored frequency to the coil.

8. The aerosol generating system of claim 7, further comprising the cigarette,
wherein the cigarette comprises:
a nicotine transfer unit configured to be heated by the susceptor;
a nicotine generator connected to a downstream end of the nicotine transfer unit and configured to be heated by the susceptor; and
a filter unit connected to a downstream end of the nicotine generator.

9. The aerosol generating system of claim 7, wherein the controller determines the frequency at which the output current becomes maximum by changing the frequency of the test voltage within a preset range, and stores the determined frequency in the memory.

10. The aerosol generating system of claim 7, wherein the controller, after the frequency at which the output current of the coil becomes maximum is stored in the memory, in response to a user input for heating the susceptor, applies the operating voltage to the coil without applying the test voltage to the coil.

11. The aerosol generating system of claim 9, wherein the controller, when a maximum value of the output current is less than a preset reference value, determines that the coil is abnormal and does not supply power to the coil.
